(19) United States
(12) Patent Application Publication
(10) Pub. No.: US 2017/0222502 A1
(43) Pub. Date: Aug. 3, 2017

(54) Production Method for a Rotor of a Reluctance Machine and Rotor for a Reluctance Machine

(71) Applicant: KSB Aktiengesellschaft, Frankenthal (DE)

(72) Inventors: Daniel GONTERMANN, Frankenthal (DE); Jochen SCHAAB, Frankenthal (DE); Michael KOENEN, Frankenthal (DE)

(21) Appl. No.: 15/328,136

(22) PCT Filed: Jul. 23, 2015
(86) PCT No.: PCT/EP2015/066830

§ 371 Date: Jan. 23, 2017

(30) Foreign Application Priority Data
Jul. 23, 2014 (DE) 102014214392.6

(51) Int. Cl. H02K 1/22; H02K 15/02

(52) U.S. Cl. CPC H02K 1/22; H02K 15/02; H02K 2213/03

(57) ABSTRACT

A method for producing a rotor for a reluctance machine, in particular for a synchronous reluctance machine, and a rotor produced by the method, are provided. The laminated rotor core is produced by punching and stacking two or more adjacent laminations of the core. The adjacent laminations are held together by at least one connection point created during the punch stacking, the at least one connection point simultaneously forming a flux barrier of the rotor. The rotor comprises a laminated core, which is stacked from at least two lamination sheets, with the at least two adjacent lamination cuts being connected to each other by at least one connection point forming at least one flux barrier of the rotor.

### CROSS REFERENCE TO RELATED APPLICATIONS

This application is a continuation of PCT International Application No. PCT/EP2015/066830, filed Jul. 23, 2015, which claims priority under 35 U.S.C. §119 from German Patent Application No. 10 2014 214 392.6, filed Jul. 23, 2014, the entire disclosures of which are herein expressly incorporated by reference.

### BACKGROUND AND SUMMARY OF THE INVENTION

The invention relates to a method for producing a rotor for a reluctance machine, in particular for a synchronous reluctance machine, wherein the sheet packet of the rotor is produced by means of stamped packet assembly. The invention relates, moreover, to a rotor as well as a reluctance machine with a rotor of such a type.

Rotors for synchronous reluctance machines conventionally include a cylindrical soft-magnetic element which is arranged coaxially on the rotor axis. As a rule, a stacked sheet packet is used for this purpose. For the purpose of forming at least one pole-pair or gap-pair, in the radial direction the rotor comprises flux-conducting portions and also flux-barring portions which differ from one another by virtue of a variably pronounced magnetic permeability. The portion having high magnetic conductivity is defined as the d-axis of the rotor, and the portion having comparatively low conductivity is defined as the q-axis of the rotor.

The sheet packet consequently comprises a large number of electric sheets stacked on top of one another, which exhibit the desired sheet-section geometry with flux-conducting portions and flux-barring portions.

Hitherto, the individual sheet sections for a rotor packet have been stamped out and stacked. The fixing of the sheet sections is then undertaken by bracing. The necessary process steps can be summarized as follows.

1. Stamping the rotor sheets.

2. Inserting the end disks onto the threading mandrel.

3. Stacking the individual sheets onto a threading mandrel, and production of the bevel.

4. Applying the top cover disk and compressing the packet.

5. Measuring the length of the packet.

6. Pressing the packet onto the motor shaft.

7. Securing the packet by an axial locking ring.

8. Truing the rotor to the nominal dimension.

9. Counterbalancing the rotor by means of a positive or negative balancing method.

An alternative production method is adopted for the production of rotors for electric motors that do not operate in accordance with the reluctance principle. These include, in particular, motors that run in a high to very high number of units or that are of highly filigree construction. In the course of the method being used for stamped packet assembly, the necessary sheets are stamped out of a sheet-metal strip and are simultaneously stacked in one step. In addition, during the stamping operation in the stamping tool the connections between the individual sheets are introduced in one stage. These points of connection, designated as “interlocks”, may have been realized in the form of packet-assembly lugs which engage with corresponding mating points—in particular, depressions—of the adjacent sheet packet and thereby form a clamping connection between individual sheets. A more extensive function has not been attributed to these points of connection hitherto.

The object of the present invention is concerned with the optimization of a production method especially for rotors of a reluctance machine that exhibit the previously discussed structure with flux-barring portions and flux-conducting portions.

The essential central idea of the invention consists in applying the already known method for stamped packet assembly also in connection with the production of a rotor for reluctance machines. Certain advantages result from the combination of these two technologies.

In accordance with the invention, during the stamped packet assembly at least one point of connection is generated which holds together two or more adjacent rotor sheets of the stacked sheet packet of the rotor. In this case the at least one point of connection is formed and arranged in such a manner that, in addition to the pure connecting function, a flux-barring action for the rotor function is attributed to said point of connection at the same time. Accordingly, at least one flux barrier of the rotor serves at the same time as a point of connection between at least two adjacent sheets of the rotor packet.

Of course, various points of connection may constitute several flux barriers. It is also conceivable that all the flux barriers likewise constitute points of connection between the packets. In appropriate manner, however, only a limited number of flux barriers are constituted by one or more points of connection.

The rotor may preferentially be suitable for a synchronous reluctance machine, in particular for a reluctance motor, particularly preferably for a synchronous reluctance motor. The arrangement of the individual flux-conducting regions and flux-barring regions may have been modeled on that according to patent U.S. Pat. No. 5,818,140 to Vagati.

Ideally, the at least one point of connection, which simultaneously constitutes a flux barrier of the rotor, is situated in the region of the flux-barrier portion of the sheet-section geometry. The at least one point of connection is preferentially situated on the q-axis of the rotor, ideally symmetrically with respect to the q-axis. Also conceivable is an arrangement of the at least one point of connection in the immediate vicinity of the q-axis.

The rotor itself may have been realized as an internal rotor or external rotor.

One or more points of connection may include one or more stamped packet-assembly lugs which engage with one or more matching mating points—in particular, a depression—of the adjacent sheet. In this way, a clamping connection between adjacent sheet packets is preferentially generated. The sheets in the middle layers of the rotor preferentially each include depressions and packet-assembly lugs. In this case, at least one packet-assembly lug forms at least one flux barrier.

Ideally, the flux barriers that are exterior in the radial direction—ideally, the flux barriers that are exterior in the radial direction on the q-axis—are formed by points of connection. In the case where use is made of the aforementioned Vagati design, the rotor design is composed of a total of four flux-barrier quadrants. In this case it is expedient if the flux barriers situated in the radial direction on the outer edge of the rotor are constituted by appropriate points of connection of the method for stamped packet assembly.

It is conceivable that an individual flux barrier has been formed by a single large point of connection. However, there is also the possibility that a single flux barrier is constituted by a certain number of separate, adjacently arranged points of connection, and these points of connection—considered in themselves—are preferentially smaller in relation to a single large point of connection.

In the case of the production method mentioned in the introduction, the necessary end disks were used for counterbalancing the rotor. In particular, the balancing mass was fitted in the annular groove of the end disk. Through the use of the method for stamped packet assembly, such an elaborate counterbalancing of the rotor is no longer necessary. The design of the necessary end disks of the rotor according to the invention can turn out to be smaller, and, if need be, an optimized balancing is undertaken.

The method according to the invention serves, in particular, for producing a sheet packet of the rotor that has a diameter of less than or equal to 150 mm. In addition, the resultant rotor may be distinguished by an axial length of less than or equal to 200 mm.

The invention relates, moreover, to a rotor for a reluctance machine, in particular for a synchronous reluctance machine, said rotor comprising a sheet packet that has been stacked from at least two sheet sections, and at least two adjacent sheet sections have been connected to one another via at least one point of connection. In accordance with the invention, at least one point of connection has been dimensioned and arranged in such a manner that it serves at the same time as at least one flux barrier of the rotor.

One or more points of connection may include one or more packet-assembly lugs—in particular, stamped packet-assembly lugs—that engage with one or more matching mating points—in particular, a depression—of the adjacent sheet. In this way, a clamping connection between adjacent sheet packets is preferentially generated.

At least one flux barrier may be constituted by one large point of connection or by a certain number of adjacent points of connection.

The rotor according to the invention has preferentially been produced in accordance with the method according to the invention or an advantageous configuration of the method. The advantages and properties of the method according to the invention are also applicable, without restriction, to the rotor according to the invention, for which reason a repetitious description will be dispensed with at this point.

In addition to the rotor, the method also relates to a reluctance machine, in particular a synchronous reluctance machine, particularly preferably a synchronous reluctance motor, with the rotor according to the invention. Also with respect to the reluctance machine, the same advantages and properties result that have already been described with reference to the method according to the invention.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 shows a cross-section view of a rotor in accordance with an embodiment of the present invention

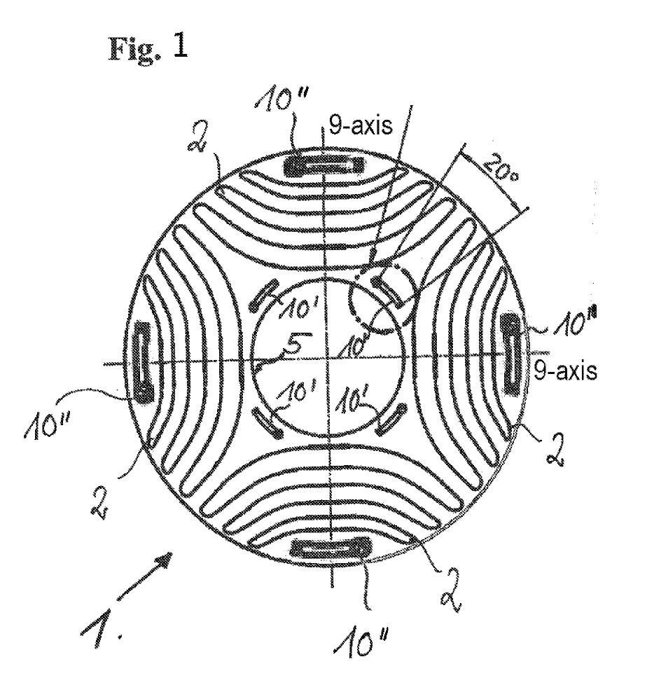

### DETAILED DESCRIPTION

The single figure shows an individual sheet section 1 of the rotor according to the invention for a reluctance motor. For the purpose of simplifying the representation, the stator has not been illustrated. The rotor sheet 1 shown can be subdivided into four identically constructed sectors of a circle, each sector being provided with several recesses 2 which perform the function of flux barriers. By virtue of the arrangement of the flux barriers 2, a four-pole rotor is formed, the magnetic flux of which is inhibited in the regions with flux barriers 2. The portions having high magnetic conductivity are characterized as the d-axis, and the region of lower magnetic conductivity is characterized as the q-axis.

For the production of the rotor, several rotor sheets 1 are stamped out of a supplied sheet-metal strip and, in the same step, are stacked in the axial rotor axis to yield the resultant sheet packet of the rotor. The connection between the individual sheet sections 1 of the sheet packet is effected via so-called stamped lugs which engage with corresponding mating points of the underlying sheet section 1 and establish a clamping connection between the sheet sections 1. The points of connection bring about a more axial fixing and a torsionally stiff connection between the sheet sections 1.

In the illustration, the sheet section 1 displays a total of eight packet-assembly lugs 10, a total of four lugs 10′ having been arranged symmetrically around the center bore 5 of the sheet section 1.

The exterior packet-assembly lugs 10″ are situated in the radial direction at the outer edge of the sheet section 1, distributed symmetrically with respect to the midpoint of the sheet section 1. These packet-assembly lugs 10″ simultaneously constitute the exterior flux barriers of the total of four flux-barring portions of the sheet packet.

In the case of the solution according to the invention, two commercially available technologies are combined in advantageous manner, and the synergistic effects resulting thereby are exploited. On the one hand, the stamped packet assembly is employed for the production of a rotor for a reluctance machine, in which connection the packet-assembly lugs to be provided here in any case are utilized simultaneously as flux barriers. In this case, the outermost flux barriers 10″ are introduced into the sheet during the packet-assembly process.

The invention offers a reliable process for production of a rotor packet for a reluctance machine. A stable support of the individual sheet sections 1 of a sheet packet is obtained, by virtue of which a better handling in manufacture can be achieved. In comparison with the previous methods for manufacturing rotors of reluctance machines, a disadvantageous overspeeding of the sheet packet no longer occurs. In addition, the otherwise necessary end disks may be dispensed with or may be dimensioned to be distinctly smaller, since the elaborate counterbalancing of the rotor is no longer necessary. The end disks can turn out to be significantly smaller, by virtue of which a new design with an optimized balancing is possible. Also, the elastic expansion of the packet can be dispensed with completely.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1-10. (canceled)

11. A method for producing a rotor for a synchronous reluctance machine, comprising the acts of:
stacking a plurality of stamped rotor packet sheets, each sheet having at least one flux barrier and at least one connection point, on a common axis with the connection points of the plurality of stamped rotor packet sheets axially aligned; and
engaging the connection points of adjacent sheets of the plurality of stamped rotor packet sheets with one another in a manner which axially fixes the adjacent sheets together by inter-connection.
wherein the connection points are configured as flux barriers.

12. The method as claimed in claim 11, wherein the connection points each include a stamped packet-assembly lug arranged to be inserted into a corresponding mating point of an adjacent sheet.

13. The method as claimed in claim 11, wherein the connection points of the plurality of stamped rotor packet sheets are arranged in flux-barrier portions of the plurality of stamped rotor packet sheets containing a q-axis of the rotor.

14. The method as claimed in claim 13, wherein at least one of the at least one flux barriers is at least one connection point of the at least one connection points of the plurality of stamped rotor packet sheets that is located at a radially outer region of the sheets.

15. The method as claimed in claim 14, wherein the at least one connection point configured as a flux barrier located in the radially outer region of the plurality of stamped rotor is a single connection point or a multi-segment connection point having a plurality of separate adjacent connection point segments.

16. The method as claimed in claim 11, wherein the rotor is an internal rotor or an external rotor.

17. The method as claimed in claim 11, wherein the stack of the plurality of stamped rotor packet sheets has at least one of a diameter of less than or equal to 150 mm and an axial length of less than or equal to 200 mm.

18. A rotor for a synchronous reluctance machine, comprising:
a plurality of stamped rotor packet sheets stacked on a common axis,
wherein
each sheet of the plurality of stamped rotor packet sheets includes at least one flux barrier and at least one connection point,
the plurality of stamped rotor packet sheets are stacked with the connection points of the plurality of stamped rotor packet sheets axially aligned,
the connection points of adjacent sheets of the plurality of stamped rotor packet sheets axially fixes the adjacent sheets together by inter-connection, and
the at least one connection point of each sheet of the plurality of stamped rotor packet sheets is configured as a flux barrier.

19. A synchronous reluctance machine, comprising:
the rotor as claimed in claim 18.
